(19) United States
(12) Patent Application Publication
(10) Pub. No.: US 2008/0098176 A1
(43) Pub. Date: Apr. 24, 2008

(54) Method and Apparatus for Implementing Memory Accesses Using Open Page Mode for Data Prefetching

(76) Inventors: M. V. V. Anil Krishna, Cary, NC (US); Michael Raymond Trombley, Cary, NC (US); Steven Paul VanderWeil, Rosemount, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/550,468

(22) Filed: Oct. 18, 2006

(51) Int. Cl. G06F 12/00

(52) U.S. Cl. 711/137

(57) ABSTRACT

A method and apparatus implement memory accesses to a memory using an open page mode with data prefetching. A central processor unit issues memory commands. A memory controller receiving the memory commands, identifies a data prefetching command. The memory controller checks whether a next sequential line for the identified prefetch command is within the page currently being accessed, and responsive to identifying the next sequential line being within the current page, the current command is processed and the current page left open.

### FIELD OF THE INVENTION

The present invention relates generally to the data processing field, and more particularly, relates to a method and apparatus for implementing memory accesses to a memory using an open page mode with data prefetching.

### DESCRIPTION OF THE RELATED ART

The time taken for a central processor unit (CPU) to access main memory has a substantial impact on the overall performance of a computer system. Because it is desirable to reduce the time taken for a CPU to read or write a word from main memory or to reduce the memory latency, several mechanisms have been employed to speed this data access process. Two such methods are data prefetching and open page mode policies.

Data prefetching attempts to accommodate the long latency of memory accesses by initiating a data fetch of a memory word prior to the actual use of the word by the CPU. By far, the most common and effective use of data prefetching occurs when long streams of data are being processed by the CPU. The processing of such data streams typically produces predictable and long-running memory addressing patterns. In most cases these addressing patterns are either long sequences of consecutively addressed memory words or sequences of memory words whose addresses are separated by a fixed distance, also known as a fixed stride. The resources that must be dedicated to supporting prefetching increase with memory latency. Since any practical system has a limit on the number of such resources, the efficacy of data prefetching can diminish unless a low memory latency can be achieved.

Open-page mode memory also attempts to take advantage of typical memory access patterns. Using an open page policy, a newly-accessed memory page is left open by the memory controller with the expectation that future memory accesses will also be satisfied out the same page. Because an open page can be accessed more quickly than a closed page and memory references tend to cluster in their addressing patterns, the open page mode policy can reduce the average memory latency.

### SUMMARY OF THE INVENTION

A principal aspect of the present invention is to provide a method and apparatus for implementing memory accesses to a memory using an open page mode with data prefetching. Other important aspects of the present invention are to provide such method and apparatus for implementing data prefetching using an open page mode substantially without negative effect and that overcome many of the disadvantages of prior art arrangements.

In brief, a method and apparatus are provided for implementing memory accesses to a memory using an open page mode with data prefetching. A central processor unit issues memory commands. A memory controller receiving the memory commands, identifies a data prefetching command. The memory controller checks whether a next sequential line is within the page currently being accessed, and responsive to identifying the next sequential line being within the current page, the current command is processed and the current page left open for the identified prefetch command.

In accordance with features of the invention, when the next sequential line for a prefetch command is not within a current page, then the page for the next sequential line is opened, the prefetch command is processed, and the page is closed. When a received memory command is not a prefetch command, the current command is processed and then the current page is closed.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is block diagram representation illustrating an exemplary computer system for implementing data prefetching using an open page mode in accordance with the preferred embodiment;

FIG. 2 is a block diagram representation illustrating an exemplary memory system of the computer system of FIG. 1 for implementing data prefetching using an open page mode in accordance with the preferred embodiment; and

FIG. 3 is a flow chart illustrating exemplary operations for implementing data prefetching using an open page mode in accordance with the preferred embodiment.

### DETAILED DESCRIPTION OF THE PREFERRED EMBODIMENTS

In accordance with features of the invention, since both prefetching and open page mode memory can take advantage of similar memory addressing patterns, a method is provided for establishing a symbiotic relationship between the two. A method for implementing memory access is provided for combining the data prefetches from the CPU and open page modes in the memory.

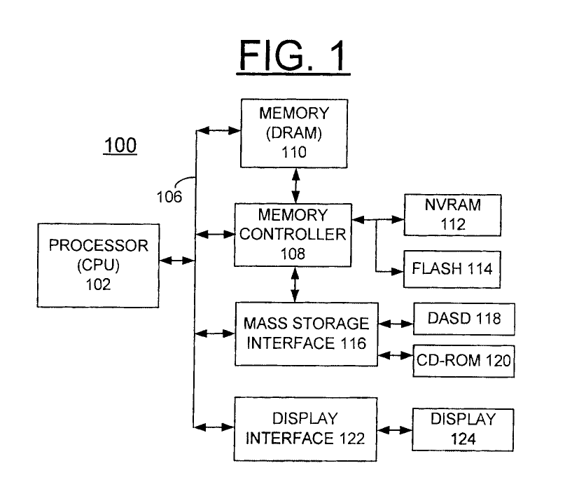

Having reference now to the drawings, in FIG. 1, there is shown an exemplary server or computer system generally designated by the reference character 100 for implementing methods for data prefetching using an open page mode in accordance with the preferred embodiment. Computer system 100 includes a main processor 102 or central processor unit (CPU) 102 coupled by a system bus 106 to a memory controller 108 of the preferred embodiment and system memory 110, such as a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 coupled to the system bus 106 and connected to a display 124.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

Various commercially available computers can be used for computer system 100, for example, an IBM personal computer or an IBM server computer, such as an IBM System p™ server computer.

Data prefetching is typically associated with the processing of long streams of data from memory because programs with these memory access patterns have the most to gain from prefetching. Conventional computer systems often contain hardware and software mechanisms to detect such access patterns and initiate data prefetches accordingly from within the CPU or one of its caches. Once prefetching is initiated, the memory system typically sees long sequences of prefetch commands to consecutive memory addresses or memory addresses separated by a small stride. The prefetch instructs the memory system to deliver the requested memory word to a location closer to the CPU such that a corresponding read or write (demand fetch) to the same address will have fast access to the word.

A prefetch command that reaches memory generally can be distinguished from an ordinary memory load by memory controllers that support prefetching. Because a prefetch typically foretells a predictable sequential memory access pattern, it can serve as a hint that several more memory accesses to subsequent memory addresses are likely to happen in the near future.

In accordance with features of the invention, memory controller 108 supports an open-page mode and uses this hint to keep the page accessed by a prefetch open for subsequent prefetches whose addresses fall within the same page. In this case, the subsequent access can deliver the requested word more quickly. This has two beneficial effects. First, the word can be prefetched more quickly to its destination close to the CPU 102 and therefore be more likely to arrive by the time the CPU issues the corresponding demand fetch. Second, issuing a prefetch operation typically consumes CPU resources until the operation completes. When the operation is completed more quickly, these resources are freed to do other work thereby improving the performance of the system.

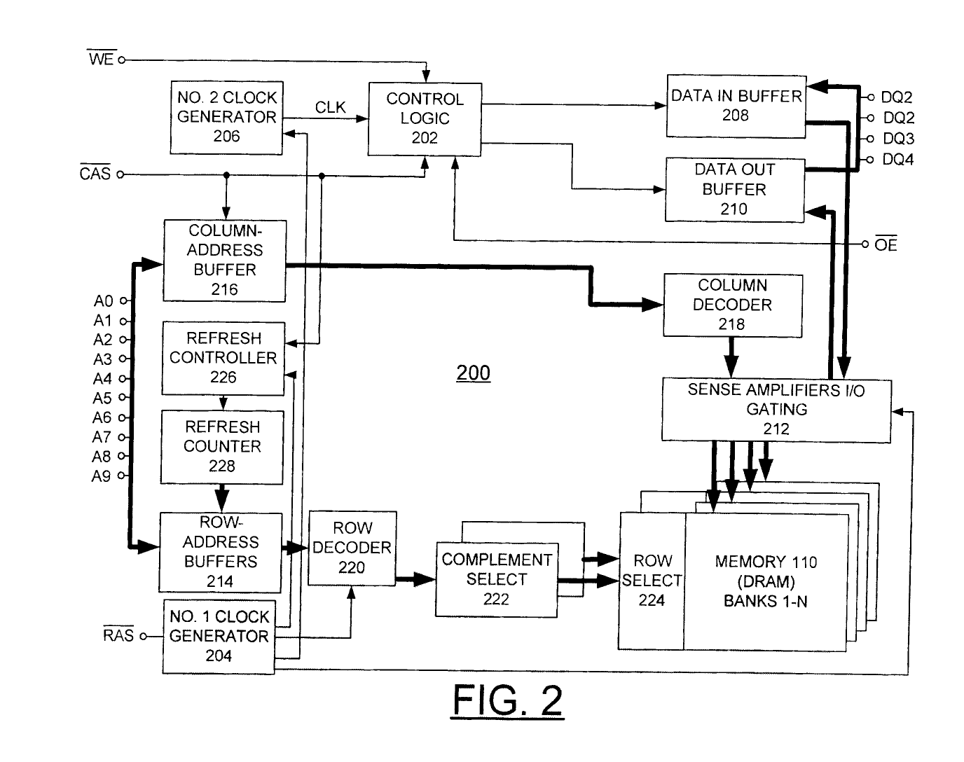

Referring also to FIG. 2, there is shown an exemplary memory system generally designated by the reference character 200 of the computer system 100 for implementing data prefetching using an open page mode in accordance with the preferred embodiment.

Memory system 200 includes control logic 202 for controlling the operation of the memory system 200 including memory accesses to the system memory 100, such as a synchronous DRAM or (SDRAM), a double data rate SDRAM (DDR SDRAM), or the like, responsive to high-level command signals, which are typically generated by a memory controller 108. System memory 100 includes a plurality of banks, 1-N, for example 4 banks as illustrated in FIG. 2. As shown, the signals coupled to the control logic 202 include a clock signal CLK, a write enable signal WE bar, a row address strobe signal RAS bar, a column address strobe signal CAS bar, and an output enable signal OE bar, where the bar indicates the signal as active low. These command signals and their respective functions are conventional.

Control logic 202 is coupled a first clock generator 204 and a second clock generator 206, with the row address strobe signal RAS bar applied to the first clock generator 204. Control logic 202 is coupled a data in buffer 208 coupled to a data out buffer 210 receiving data select signals DQ1, DQ2, DQ3, DQ4, with both buffers 208, 210 coupled to sense amplifiers I/O gating block 212, for transferring data to and from SDRAM memory array 100.

Memory system 200 includes a row address buffer 214 and a column-address buffer 216 respectively receiving row addresses and column addresses, such as address inputs, address inputs A0-A9 as shown. The column-address buffer 216 is connected to a column decoder 218, which decodes the column address and applies corresponding signals to one of the banks or arrays of memory array 100 via sense amplifiers I/O gating logic block 212. The row-address buffer 214 is connected to a row decoder 220, which receives a clock signal from the first clock generator 204. Row decoder 220 decodes the row address and applies corresponding signals via a complement selected 222 and a row select 224 to one of the banks or arrays of the memory array 100. A refresh controller 226 controlled by the control logic 202 is coupled to the first clock generator 204. Row addresses are generated for refresh purposes by a refresh counter 228 that is coupled to the row address buffer 214.

In accordance with features of the invention, the memory controller 108 is provided to decide whether or not to leave a page open based on the type of memory access being made. If the access is an ordinary demand fetch, the page should be closed after the access completes. If the access is a prefetch, the page typically should be left open.

In a closed mode page policy, memory 110 is accessed by a series of steps as follows. When the memory controller 108 receives an address from the CPU, for a read, write or prefetch, memory controller 108 identifies which memory bank contains the memory word to be accessed and sends an activate signal to that bank of memory 110. System memory 100 includes The memory controller 108 then splits the address into two segments. The fist segment is used to construct a set of signals known as the row access strobe or RAS. The second set of signals is called the column access strobe or CAS. These two segments are so named because the physical arrangement of memory 110 is a rectangular array of memory elements and the CAS and RAS can be used much like Cartesian coordinates in mathematics to access particular elements within the array.

First the RAS is presented to the data array. This opens a row or page of data that is typically in the range 16K to 64K bytes in size. After a several clock ticks, the CAS signals are used to access the particular memory word or words of interest within the page. At this point, data begins to flow from the indexed memory array 110 into a memory buffer 210 or data begins to flow to the indexed memory array 110 from the memory buffer 208. If the memory operation is a write, the page can be closed immediately after the data has been written to the memory. In the case of a read or prefetch, the page can be closed immediately after the buffer has been filled.

In an effort to speed some memory accesses, system 200 employs an open page mode. This mode allows the memory controller 108 to skip some of the above steps when the address of the current request falls in the same page as the previous request. That is, if a page is not closed when the current operation completes, a subsequent access to the same page need not activate the memory bank or assert the RAS signals. Instead, the memory controller 108 can immediately assert the CAS signals allowing the new data to flow in to, or out of, the respective memory buffer 208, 210.

One disadvantage of using open page mode for all memory accesses is that if the page left open by the last operation is different from, but in the same logical partition or memory bank as the page of the current operation, there are two steps that have to be taken before the read or write command can commence. The memory bank must be precharged in order to close all the pages in the bank, and the correct page must be activated. Another disadvantage of using open page policy is that it takes resources of memory controller 108 to keep track of the pages that are open in the system 200. Depending on the state of a particular bank, and the page that is open in the particular bank, if any, the memory controller 108 has to send an appropriate memory command. If no page is open in a particular bank for a memory request, an activate command is sent to open the required page. If the required page is already open in the bank, a read or write command is sent to the page. And, in the case a different page is already open in the bank for a memory request, the bank must be precharged first, before the appropriate page is opened by sending an activate and finally the read or write command is sent. Both these steps take a few memory cycles each. Therefore, although open page mode can be beneficial to performance, it adds logic complexity, which adds to area and power consumption.

In memory controller 108 of the preferred embodiment, the open page policy is supported while limiting the number of open pages to keep only those pages open, which are very likely to be reused.

In accordance with features of the invention, a method is provided to predict ahead of time whether or not a page is likely to be re-accessed in the near future. The method of the invention attempts to make such a prediction by treating prefetch commands differently from other memory accesses. In addition to carrying out the speculative fetch of the memory word requested by the prefetch, the memory controller 108 uses the address of the prefetch as a hint that the page containing the next sequentially addressed memory word also be opened. Two scenarios now arise:

First if this word falls in the same page as the previous word, the current page is left open and subsequent loads and stores to the page do not close the page. In the preferred embodiment, a prefetch to the last word in a page is used as a signal that the page may be closed. This scenario is more likely when the memory controller 108 hashes addresses such that consecutively addressed words fall in the same page, as is the case when a normal open page mode policy is in place.

Second if the next sequentially addressed word lies in a different memory page, this page is opened by the memory controller 108. In this scenario, the page is closed following subsequent accesses to the page. This is more likely to happen when a memory controller 108 hashes addresses such that consecutively addressed memory words fall into different pages. This sort of hashing generally is typical of memory controllers designed to support a closed mode page policy.

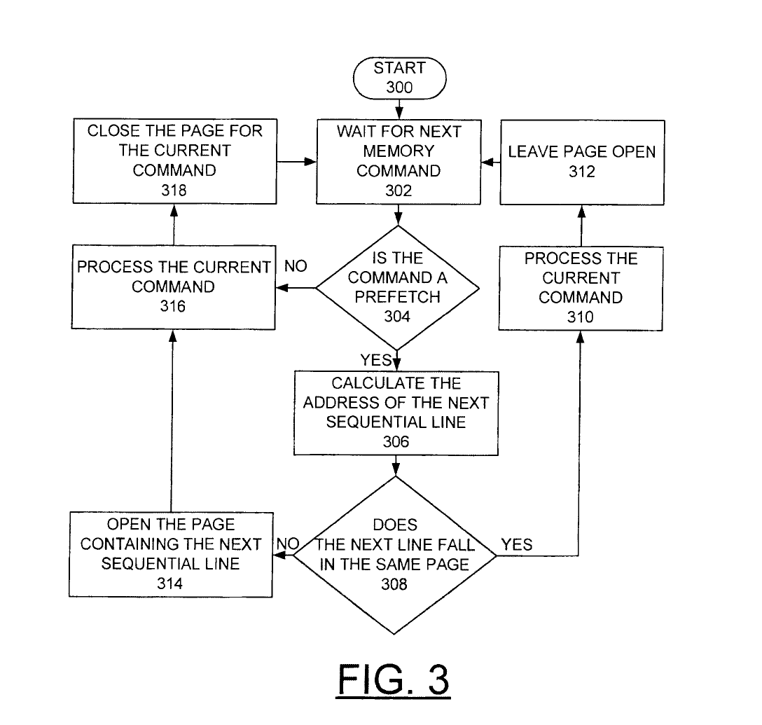

Referring also to FIG. 3, there are shown exemplary operations for implementing data prefetching using an open page mode in accordance with the preferred embodiment starting at a block 300. First waiting for a next memory command is performed as indicated in a block 302. When a command is received, checking if the command is a prefetch command is performed as indicated in a decision block 304. When a prefetch command is identified, then the address of the next sequential line is calculated as indicated in a block 306.

Then checking whether the next line falls in the same page is performed as indicated in a decision block 308. When the next line falls in the same page, then the current command is processed as indicated in a block 310 and the page is left open as indicated in a block 312.

When determined at decision block 308 that the next line does not fall in the same page, then the page containing the next sequential line is opened as indicated in a block 314. Then the current command is processed as indicated in a block 316 and the page for the current command is closed as indicated in a block 318.

When determined at decision block 304 that then command is not a prefetch command, then current command is processed at block 316 and the page for the current command is closed at block 318.

While the present invention has been described with reference to the details of the embodiments of the invention shown in the drawing, these details are not intended to limit the scope of the invention as claimed in the appended claims.

What is claimed is:

1. A method for implementing memory access to a memory comprising:
identifying a data prefetching command,
checking whether a next sequential line is within a current page being accessed, and
responsive to identifying said next sequential line being within the current page, processing the current command and leaving the current page open.

2. A method for implementing memory access as recited in claim 1 further includes waiting for a next memory command.

3. A method for implementing memory access as recited in claim 2 further includes identifying a demand fetch command, processing the demand fetch command and closing the current page.

4. A method for implementing memory access as recited in claim 1 further includes identifying said next sequential line not being within the current page, opening a page containing said next sequential line.

5. A method for implementing memory access as recited in claim 4 further includes processing the current prefetch command and closing the current page.

6. A method for implementing memory access as recited in claim 1 further includes receiving a memory command and identifying a write command, processing the write command and closing the current page.

7. A method for implementing memory access as recited in claim 11 further includes receiving a memory command and identifying a demand fetch read command, processing the read fetch command and closing the current page.

8. Apparatus for implementing memory access to a memory comprising:
a central processor unit issuing memory commands;
a memory controller receiving said memory commands, and identifying a data prefetching command,
said memory controller checking whether a next sequential line is within a current page being accessed, and
said memory controller responsive to identifying said next sequential line being within the current page, processing the current command and leaving the current page open.

9. Apparatus for implementing memory access as recited in claim 8 further includes said memory controller receiving a next memory command and checking whether said received next memory command is a data prefetching command

10. Apparatus for implementing memory access as recited in claim 9 further includes said memory controller identifying a demand fetch command, processing the demand fetch command and closing the current page.

11. Apparatus for implementing memory access as recited in claim 8 further includes said memory controller identifying said next sequential line for the current prefetch command not being within the current page, and opening a page containing said next sequential line.

12. Apparatus for implementing memory access as recited in claim 11 further includes said memory controller processing the current prefetch command and closing the current page.
